(19) United States
(12) Patent Application Publication
(10) Pub. No.: US 2011/0264500 A1
(43) Pub. Date: Oct. 27, 2011

(54) METHOD AND SYSTEM FOR AUTHENTICATED TRANSACTION HISTORY

(75) Inventors: Robert J. Bouthillier, Lincoln, RI (US); Michael P. Fusaro, Greenville, RI (US)

(73) Assignee: DESIGN NET TECHNICAL PRODUCTS, INC., Smithfield, RI (US)

(21) Appl. No.: 13/176,049

(22) Filed: Jul. 5, 2011

Related U.S. Application Data
(62) Division of application No. 12/025,244, filed on Feb. 4, 2008.

(51) Int. Cl. G06Q 30/00

(52) U.S. Cl. 705/14.23; 705/27.1; 705/14.53; 705/14.39

(57) ABSTRACT

An apparatus for registering deeds for media that includes an electronic database that may be accessed by account holders and merchants, retailers and others, and with whom account holders may interact. The electronic database contains information to authenticate the account holder and record the transaction. Means are provided for of ensuring secure access to the electronic database, as well as means for identifying one or more enrolled member accounts in the electronic database.

### TECHNICAL FIELD

The present invention relates to an improved method and system for registering and authenticating a transaction history. More particularly, the present invention pertains to an authenticated transaction history file that serves as “proof of purchase” and may serve as a means for securely storing license keys for a variety of copyrighted or licensed media types and for articles such as event tickets and electronic gifts. The system uses a database structure to create a catalog of each user's items. Members may then be afforded a discount for the purchase of items related to their previous transaction history.

### BACKGROUND OF THE INVENTION

The present invention establishes an authenticated transaction history file that serves as “proof of purchase” for a variety of copyrighted or licensed media types and for articles such as event tickets and electronic gifts. The system uses a database structure to catalog items that are referred to as “instances”. In this regard reference may be made to U.S. Pat. No. 6,904,410 to Weiss et al which describes an online method and system for the management of collectibles. The method and system that is described in the '410 patent is limited basically to only matching buyers and sellers rather than creating a catalog of each user's items as in accordance with the principles of the present invention. Reference is also made to U.S. Pat. No. 6,9102,611 which describes a method and system for implementing a loyalty merchant component. In this method and system users are afforded a discount for repeat business; however, this system does not require that any loyalty program information be provided on the user purchase card, as this information is directly entered by the user at the time of purchase in the form of a member ID or a member discount code. The entire contents of the above cited '410 and '611 patents are hereby incorporated by reference herein.

### SUMMARY OF THE INVENTION

To accomplish the foregoing and other features of the present invention there is provided an apparatus for registering deeds for media comprising: an electronic database that may be accessed by account holders and merchants, retailers and others, and with whom account holders may interact; said electronic database containing information to authenticate the account holder and record the transaction which may include license keys or access codes; means of ensuring secure access to said electronic database; and means for identifying one or more enrolled member accounts in said electronic database;

In accordance with other aspects of the present invention the deeds are purchase history or ownership records with any license data for media including books, tickets, gifts, music, movies, or other licensed material or articles; including means for an account holder to display all or part of their purchase history statistics on a website; including means for an account holder to obtain a discount code to apply to a merchant website for obtaining a discount or rebate associated with a purchase; and including means for providing the quantity of purchases of a specific type during a specific time interval.

The present invention also relates to method of creating an electronic gift comprising the steps of:

selecting a gift item from a merchant source as displayed in an online format;

selecting the source and quantity of funds to purchase the gift;
identifying a recipient by postal mail or email address or other unique means of identification for the purpose of delivery of the gift;

completing the transaction by sending the gift;

and holding the transaction in escrow as a gift deed in an electronic database.

In accordance with other aspects of the present invention there may be included a means for a gift deed recipient to retrieve the gift deed from escrow and accept delivery of the gift; and a means for a gift deed recipient to retrieve the gift deed from escrow and convert the escrow to cash which can be directed to a user account registered in a media deeds database.

### DESCRIPTION OF THE DRAWINGS

Other objects, features and advantages of the invention shall become apparent as the description thereof proceeds when considered in connection with the accompanying illustrative drawings, in which:

FIG. 1 is a block diagram illustrating typical member inventory items stored on the media deeds web server as in accordance with the present invention;

FIG. 2 is a block diagram illustrating various parties who may interact with the media deeds system of the present invention;

FIG. 3 is a flow diagram illustrating typical member activities associated with the media deeds web server;

FIG. 4 is a diagram illustrating the system access permissions associated with the media deeds webserver;

FIG. 5 is a flow chart illustrating a gift deed purchase associated with the media deeds webserver; and

FIG. 6 is a flow chart illustrating a gift deed redemption associated with the media deeds webserver.

### DETAILED DESCRIPTION

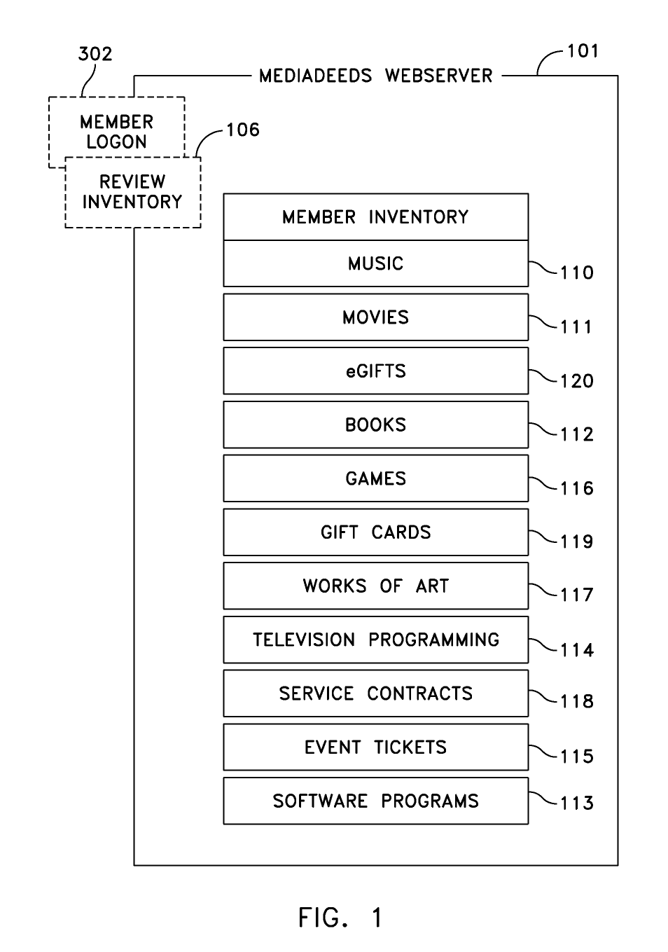

FIG. 1 shows a part of the media deeds system of the present invention. This includes a web server 101 containing the member purchase history and other data such as license keys which is accessible in various limited formats to members, merchants, advertisers and licensors via the internet, via text messaging or using a telephone. Members may access the web server to perform a number of activities including:

(a) to create an account,

(b) to review account inventory,

(c) to review inventory license status, license codes or license keys,

(d) to transfer title of an inventory item,

(e) to file a collection replacement form in the event that the purchased media becomes lost or stolen.

Inventory items recorded in this system may include any item or media format including, but not limited to, music, movies, books, software programs, television programming, event tickets, games, works of art, service contracts, gift cards and e-gifts, and license keys which may be associated with an of these items. These various inventory items are listed in FIG. 1, along with a member logon 302 and a way to review inventory at 106. In FIG. 1 the various items are described at respective boxes 110-120.

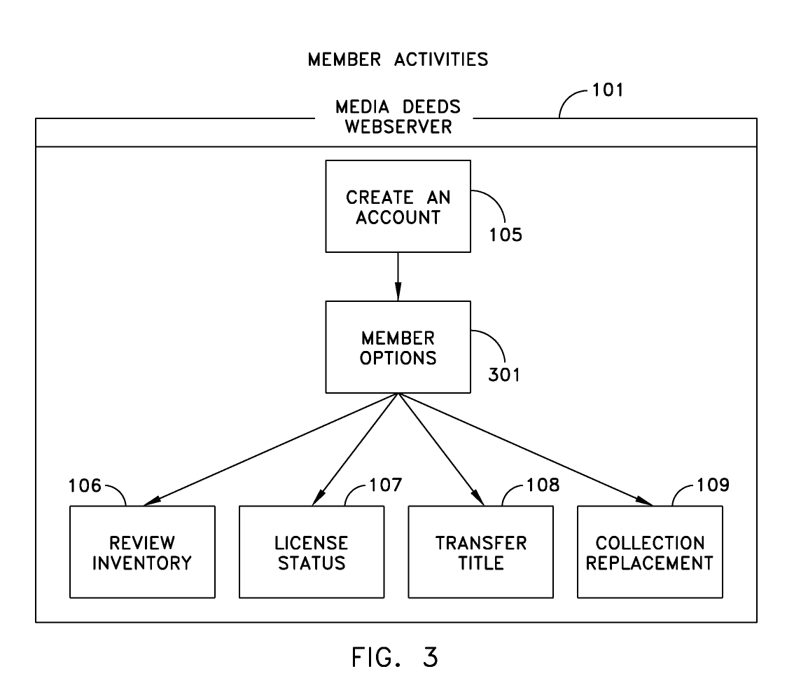

Refer also to FIG. 3 which illustrates the media deeds web server and the related actions. Box 105 represents the creation of the account. Box 301 represents the different options that are available to the member. From the options box are four other boxes that are representative of different actions. Box 106 represents an inventory review. Box 107 represents the license status. Box 108 represents a transfer of title. Box 109 represents a collection replacement.

### System Access

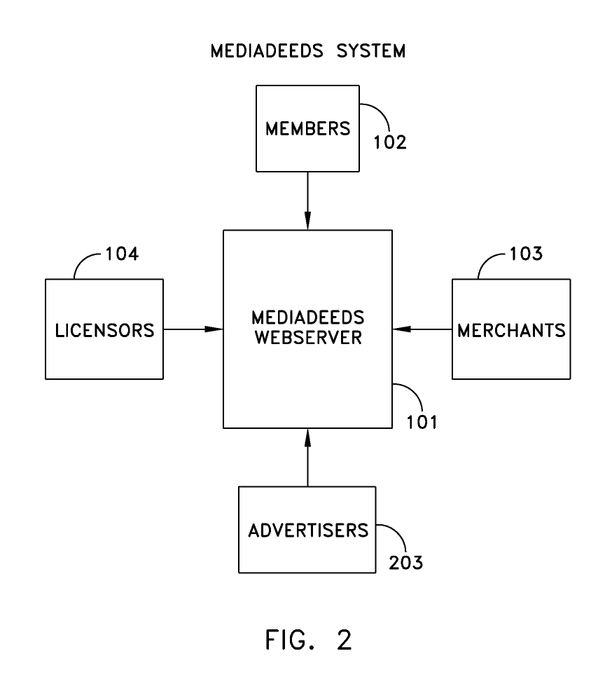

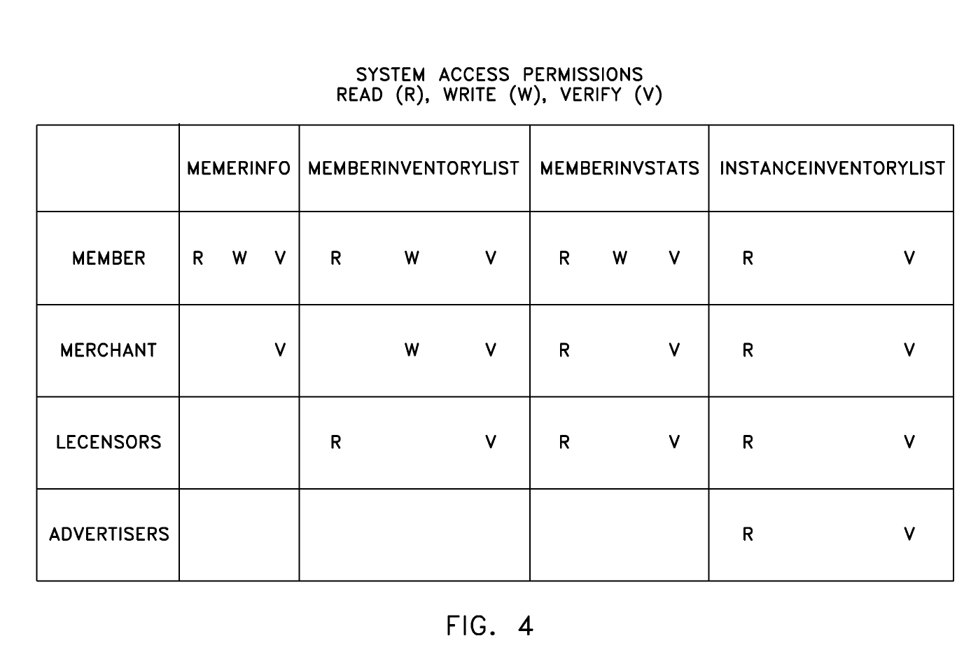

The media deeds web server 101 shown in FIG. 1 is built as a secure real-time transaction system to permit members and merchants, to access the transaction database on a real-time basis. Refer to FIG. 2 for a diagram of the interface with the web server 101. In accordance with the present invention the members 102 have access to the web server and the transaction history. The transaction history is a listing of inventory items. Licensors 104 have access to the transaction history but not member data. A typical licensor would be a music or movie distribution firm like Universal Music, Sony Pictures, etc. This access is on a lower-priority real-time basis. Advertisers 203 have access to only bulk statistical information related to total inventory, and have no access to member data. For system access permissions refer to FIG. 4 herein which is a table that relates members, merchants, licensors and advertisers, on the one hand, to member information, the member inventory list, the member inventory status and the instance inventory list.

### Database Format

The web server database stores information as a database of “instances” of each item including a unique product identifier such as a Product Description, SKU, ISBN, or Manufacturer Part Number and Revision, and each user record references one or more of these “instances” to form the user record. This technique is used in object-oriented programming and has been implemented efficiently in other online transaction systems including that described in the aforementioned U.S. Pat. No. 6,904,410 that has been used to match buyers and sellers.

### Member Access

The media deeds system requires members to create an account using personal information that may be used to authenticate a member. This information may include name, address, date of birth, social security number, and the like. One or more credit card numbers or identifications associated with other credit or debit account purchase vehicles may also be provided if the member wishes to use this membership in merchant purchase programs. A member-controlled “ad-stack” advertising feature allows members to browse ads for events, music, movies, and other information related specifically to the content and the history of their database record. The ad feature may also adapt to member actions and may prioritize content based upon these actions.

Each ad is supplied to the ad-stack for members whose inventories contain that item. Members can then prioritize the viewing of their ad content and may have the ability to rate, delete or to mark an ad as “spam”. Viewer actions resolve to a grading system whereby higher-graded ads are pushed closer to the top of the “ad-stack”.

Other examples showing members use of this system include the following:

### Use of Widgets

Members may use a widget to provide access to their account or to display purchase history “status” in a format easily displayed on a web page. Widgets may also be used in an interactive manner with other members' widgets to identify articles that one or more members have in common such as movie titles, games, books, or the like.

### Movie/Programs Access

Members may use this system to gain access to license keys required to unlock or decode programs or movies that are listed in their inventory or that were purchased thru media deeds participating merchants. Discounts may also be offered to member by participating merchants. Movies may also be transferred to others by members thru use of license keys or other means as permitted by the movie studio license agreements.

### Music

Members may receive discounts from participating merchants when pre-defined purchase thresholds are reached. The history or purchases may also be used to replace a lost music collection without payment of license fees. Music may also be transferred to others thru use of license keys or other means as permitted by the music owner or label license agreements.

### Event Ticket Purchases

Members may be given priority when purchasing event tickets as the merchant can verify that only one purchase has been made per address or per user through use of the user authentication in the database. Lost or stolen tickets may also be replaced by the merchant.

Members may also use this system to transfer title of an inventory item to another member. This may apply to any item in the member's inventory provided that it does not violate the terms of any license agreements provided by the licensor.

Gift cards may also be purchased on the site or at participating retailers for use at member sites with the discounts applied, or they may be exchanged for a popular branded debit card for use at any merchant who accepts that card. eGifts may also be offered permitting the members to register and send an eGift to anyone by selecting a gift from a merchant site, saving the shopping cart, and submitting payment on the media deeds web server. The recipient receives an email notice with the prepaid gift attached, and they may accept the gift whereby we complete the transaction with the merchant, or the recipient may use their own media deeds account to exchange it for credit applied to a popular branded debit card.

### Merchant Access

Merchants must register to participate in the media deeds system. Upon acceptance, they will be given access to the API (application programming interface) to enable them to interact with member accounts, as appropriate. Merchants may access the media deeds system to verify member-provided information, verify inventory statistics, create and verify a new inventory item with optional record information such as security keys, or to read the system instance inventory records. This information can be used, for example, for music purchase discounts. Members may be offered discounts when purchase activity exceeds one or more thresholds. They may also be offered “collection replacement” guarantees whereby in the event of a loss of licensed content, that content will be replaced for only a handling fee.

An application programming interface (API) is the set of commands that a programmer will use to interact with a website or a server. For example, companies like RBS Systems allow merchants to process credit card payments from a website using a set of “API calls” or commands that will allow them to send a command to “check available funds” which returns an authorization number, then they can send a command to “post a purchase transaction”, and finally they request the forwarding of payment to the merchant account via Electronic Funds Transfer (EFT) using the “Settlement” command at the end of the day.

### Movie Rental/Purchases

Merchants may store secure access keys in the transaction record to either limit the number of movies permitted to be “out” at once, or to provide access to only the licensee.

### Event Ticket Purchases

Merchants may authenticate ticket holders' purchase requests to limit purchases to one per address, and purchase history information may be used to replace lost or stolen tickets.

### Licensor Access

Licensors must register to participate in the media deeds system. Upon acceptance, they will be given access to the API to enable them to interact with member accounts as appropriate. The system access permissions diagram of FIG. 4 describes the model for licensor accessibility to the system. Typical access usage may include verifying purchase history statistics, supplying decode keys for movies, programs, games or other media, verifying license transfer information, and more.

### Advertiser Access

Advertisers must register to participate in the media deeds system. Upon acceptance, they will be given access to the API to enable them to interact with the Instance database and to post ads. While advertisers have the most limited access to the media deeds system database, it will also be a most powerful directed advertising vehicle. Advertisers may post an “ad” with a link to the Instance Inventory List of the media deeds system. Each “ad” will be supplied to the “ad-stack” for members whose inventories contain that item. Members prioritize the viewing of their ad content and may have the ability to rate, delete or to mark an ad as “spam”. Viewer actions will resolve to a grading system whereby higher-graded ads are pushed closer to the top of the “ad-stack”.

### Descriptions Relating to FIGS. 4-6

FIG. 4 illustrates the secure access model of the media deeds web server database whereby members have access to their personal information, their inventory list, their statistics (total items, discount thresholds) and system-wide inventory statistics (totals of each item registered on the site). However, merchants, licensors, and advertisers have only limited access to this data.

The table in FIG. 4 entitled “System Access Permissions” displays the permissions or access rights granted to each type of registered user (Member, Merchant, Licensor, and Advertiser) on the Media Deeds WebServer. Merchants, Licensors, and Advertisers have more limited permissions to protect the privacy of Member data.

Registered members have the least restricted access. Members can view read, write, and verify (R, W, V) MemberInfo, MemberInventoryList, MemberInvStats, and can read and verify the InstanceInventoryList.

Registered Merchants are given access to the API to enable them to interact with member accounts as appropriate. Merchants may access the media deeds system to verify member-provided information (MemberInfo), read and verify inventory statistics (MemberInvStats), create (write) and verify a new inventory item (MemberInventoryList) with optional record info such as security keys, or to read and verify the system InstanceInventory records.

Registered Licensors will be given access to the API to enable them to interact with member accounts as appropriate. Licensors may access the Media Deeds system to read and verify the MemberInventoryList, MemberInvStats, and InstanceInventoryList. Typical access usage may include verifying purchase history statistics, supplying decode keys for movies, programs, games or other media, verifying license transfer information, and more.

Registered Advertisers are given access to the API to enable them to interact with the Instance Database and to post ads. Advertisers, however, will have the most limited access to the media deeds system database, their only permissions are to read and verify the InstanceInventoryList.

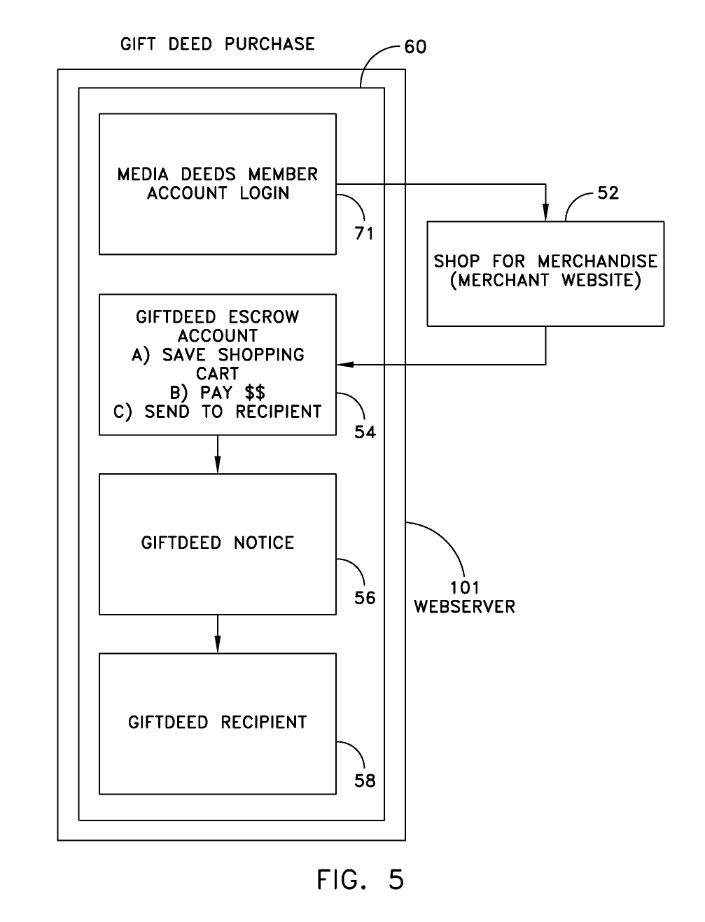

FIG. 5 shows the process for completing a Gift Deed Purchase. Using the WebServer 101, the Member selects Gift Deed Purchase 60 and logs in to his or her account on the Member Login screen 71. The Member then selects Shop for Merchandise 52 and is redirected to the desired website. After selecting a gift, the Member is directed back to the Gift Deed Escrow Account 54 on the WebServer 101 where the Member is able to save the shopping cart containing the selected gift, pay for the gift, and send it to the Gift Deed Recipient 58. A Gift Deed Notice 56 is sent to the Gift Deed Recipient 58.

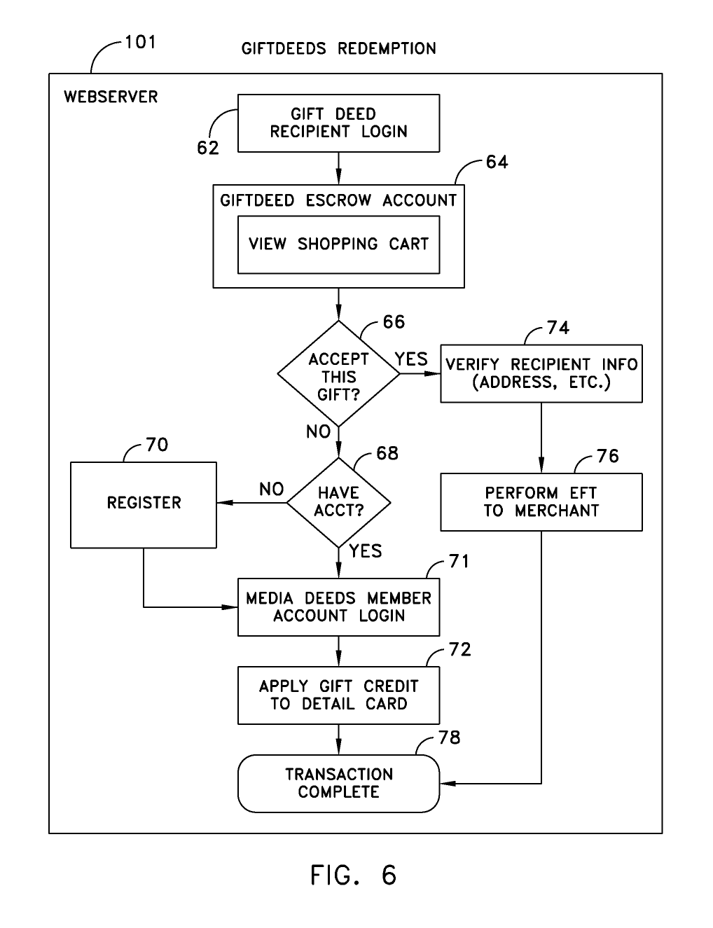

FIG. 6 shows the process for Redeeming a Gift Deed. Using the web server 101, the Gift Deed Recipient selects Gift Deed Recipient Login 62 on the Media Deeds web server 101. The Gift Deed Recipient is brought to the Gift Deed Escrow Account 64, where he or she can view the gift in their shopping cart. The Gift Deed Recipient must decide whether or not to Accept This Gift at 66. If this gift is accepted, the Gift Deed Recipient is asked to Verify or update Recipient Info 74, and when they submit this, an Electronic Funds Transfer (EFT) 76 is performed to the merchant, and the Transaction is complete at 78. If the Gift Deed Recipient decides not to Accept This Gift 66 he or she can Register as a Media Deeds Member 70, or use their existing Media Deeds Membership to log into their Media Deeds Account 71 and choose to apply the Gift Credit to a popular branded debit card 72, and the Transaction will be complete at 78.

Having now described a limited number of embodiments of the present invention it should now be apparent to those skilled in the art that numerous other embodiments and modifications thereof are anticipated as falling within the scope of the present invention, as defined by the appended claims.

What is claimed is:

1-5. (canceled)

6. A method of creating an electronic gift comprising the steps of:
selecting a gift item from a merchant source as displayed in an online format;
selecting the source and quantity of funds to purchase the gift;
identifying a recipient by postal mail or email address or other unique means of identification for the purpose of delivery of the gift;
completing the transaction by sending the gift;
and holding the transaction in escrow as a gift deed in an electronic database.

7-8. (canceled)

9. The method of claim 6 further comprising the steps of retrieving the gift deed from escrow and enabling a user to accept delivery of the gift.

10. The method of claim 6 further comprising the steps of retrieving the gift deed from escrow and converting the escrow to cash that can be directed to a user account registered in a media deeds database.

11. The method of claim 6 further comprising the step of providing an advertising feature that allows a member to browse advertisements for events, music, movies, and other information related specifically to content and history of a database record of the member.

12. The method of claim 6 further comprising the step of enabling advertisers to post advertisements in an instance database, the instance database containing records of system inventory.

13. The method of claim 12 further comprising the step of offering discounts to members when purchase activity exceeds one or more thresholds.

14. The method of claim 13 further comprising the step of offering a replacement guarantee when, in the event of licensed content, the licensed content is replaced for a charge of a handling fee.

15. A method for registering deeds for media, the method comprising the steps of:
authenticating an account holder to an electronic database that is accessed by account holders, merchants and advertisers;
establishing a transaction history based upon transactions between the account holder and a merchant;
creating a member database record for the account holder based upon the transaction history, the member database record being stored in the electronic database;
providing advertisements to the account holder, the advertisements being related to the transaction history for the account holder; and
identifying one or more enrolled purchase accounts in the electronic database.

16. The method of claim 15 further comprising the step of providing a quantity of purchases of a specific type during a specific time interval.

17. The method of claim 5 wherein the deeds comprise purchase history or ownership records with license keys for media including books, tickets, gifts, music, movies, or other licensed material or articles.

18. The method of claim 15 wherein the deeds comprise purchase history or ownership records without license keys for media including books, tickets, gifts, music, or other licensed material or articles.

19. The method of claim 15 further comprising the step of displaying at least a part of the transaction history for the account holder on a website.

20. The method of claim 15 further comprising the step of applying a discount code for the account holder to a merchant website for obtaining a discount or rebate associated with a purchase.

21. The method of claim 15 further comprising the step of providing an advertising feature that allows a member to browse advertisements for events, music, movies, and other information related specifically to content and history of a database record of the member.

22. The method of claim 21 further comprising the step of adapting the advertising feature to actions of the member.

23. The method of claim 22 further comprising the step of prioritizing content for the member based upon the actions of the member.

24. The method of claim 21 further comprising the step of enabling the member to rate at least one of the advertisements, delete at least one of the advertisements or mark at least one of the advertisements as spam.

25. The method of claim 21 further comprising the step of enabling advertisers to interact with an instance database, the instance database containing records of system inventory.

26. A non-transitory computer-readable medium containing executable program instructions for authenticated transaction histories, the executable program instructions comprising program instruction for:
authenticating an account holder to an electronic database that is accessed by account holders, merchants and advertisers;
establishing a transaction history based upon transactions between the account holder and a merchant;
creating a member database record for the account holder based upon the transaction history, the member database record being stored in the electronic database;
providing advertisements to the account holder, the advertisements being related to the transaction history for the account holder; and
identifying one or more enrolled purchase accounts in the electronic database.

27. The method of claim 26 further comprising instructions for offering discounts to members when purchase activity exceeds one or more thresholds.
